(19) United States
(12) Patent Application Publication
(10) Pub. No.: US 2024/0105370 A1
(43) Pub. Date: Mar. 28, 2024

(54) High-entropy Soft Magnetic Alloy with 900 K High-temperature Resistance

(71) Applicants: NCS Testing Technology CO., LTD, Beijing (CN); University of Science and Technology Beijing, Beijing (CN)

(72) Inventors: Haizhou Wang, Beijing (CN); Runqiu Lang, Beijing (CN); Haiyang Chen, Beijing (CN); Yandong Wang, Beijing (CN); Lei Zhao, Beijing (CN); Changwang Zhu, Beijing (CN); Xiaofen Zhang, Beijing (CN); Lixia Yang, Beijing (CN); Dongling Li, Beijing (CN); Xuejing Shen, Beijing (CN); Yunhai Jia, Beijing (CN)

(21) Appl. No.: 18/530,485

(22) Filed: Dec. 6, 2023

(30) Foreign Application Priority Data
Dec. 28, 2022 (CN) 202211698801.0

(51) Int. Cl. H01F 1/153; C22C 1/02; C22C 30/00; C22C 33/04; C22C 38/02; C22C 38/06; C22C 38/10

(52) U.S. Cl. CPC H01F 1/153; C22C 1/02; C22C 30/00; C22C 33/04; C22C 38/02; C22C 38/06; C22C 38/10; C22C 38/105; C22C 2202/02

(57) ABSTRACT

The present invention discloses a high-entropy soft magnetic alloy with 900 K high-temperature resistance, comprising Fe, Co, Ni, Si and Al, and the atomic percent of the alloy composition is expressed as FeₓCo_{y}Ni_{z}SiₘAlₙ, wherein x=40%-80%, y=20%-60%, z=0-30%, m=0-20%, n=0-20%, and x+y+z+m+n=100%; the atomic percent of other doping elements is p=0-5%, and 0.5≤m/n≤3; the performance indexes of the material include: at room temperature, saturation magnetization Mₛ=90-150 emu/g, and coercive force H_{c}=0.1-15 Oe; and at 900 K, saturation magnetization Mₛ=70-130 emu/g, and coercive force H_{c}=0.1-25 Oe. The high-entropy soft magnetic alloy with 900 K high-temperature resistance of the present invention realizes the continuously diffuse distribution of nano-scale precipitates in the matrix structure by comprehensively regulating the microstructure configuration of the multi-principal element alloy, thus improving the soft magnetic properties of the alloy to a certain extent, and the processing route is simple and reliable, with high repeatability.

### TECHNICAL FIELD

The present invention relates to the technical field of new materials, in particular to a high-entropy soft magnetic alloy with 900 K high-temperature resistance.

### BACKGROUND

Soft magnetic materials, as metal functional materials to realize electromagnetic conversion, are widely used in all industrial sectors and directly affect the production activities of the national economy. Compared with permanent magnet materials, the soft magnetic materials have higher saturation magnetization (Mₛ) and coercive force (H_{c}), and can realize electro-electric conversion, electro-magnetic conversion and magneto-electric conversion under the premise of low loss. With the rapid development of the third generation wide bandgap semiconductors and 5G high frequency communication technology, the demand for advanced soft magnetic materials with excellent high-temperature resistance and low loss is becoming increasingly urgent in emerging science and technology sectors and electronic information technology. The soft magnetic materials used in traditional industrial sectors, such as metal-based soft magnetic materials, soft magnetic ferrite materials, amorphous and nanocrystalline soft magnetic materials and soft magnetic composite materials, are seriously inadequate, which cannot meet the performance of high Mₛ and low H_{c}, while having intrinsic properties such as high Curie temperature (T_{c}) and high resistivity (ρ).

The traditional metal-based soft magnetic alloys are still highly dependent on the traditional alloy design methods so far, that is, replying on one or two main elements as the principal element of the matrix, by adding a small amount of alloying or micro-alloying element to adjust the comprehensive performance of the alloy, supplemented by material forming methods and heat treating regimes to comprehensively regulate the performance. It can be seen that the traditional metal-based soft magnetic alloys have high composition dependence and process dependence and only have good performance in one aspect, and thus cannot meet the performance requirements of the new generation of soft magnetic materials.

The emergence of high-entropy alloys provides new opportunities and challenges for the exploration of novel soft magnetic alloy material systems. The high-entropy alloys are multi-principal element alloys, which are characterized by the presence of multiple major components at the same time. The high-entropy alloys are broadly defined as: a mixture of five or more elements at an equimolar or near-equimolar ratio, wherein the content of each element is 5%-35%. With the continuous development of the high-entropy alloys, the high-entropy alloys defined in terms of the calculated entropy have broadened the types and contents of alloy elements, which is mainly manifested as four principal elements with contents no longer limited to 5%-35%. However, the chaos property of the high-entropy alloys makes it difficult for the elements to have long-range diffusion, and the affinity difference of different components at different temperatures also leads to the genetic behaviors of various complex clusters. The above effects make the high-entropy alloys easy to form short-range order structures, and also tend to form simple structures rather than complex intermetallic compounds, such as a body-centered cubic phase (A2), a face-centered cubic phase (A1) and the ordered superstructures (B2, L1₂, L2₁, etc.) thereof. Through the design and regulation of the microstructure of the high-entropy alloys, novel high-performance metal structural materials and metal functional materials with multi-physics coupling complex serviceability in extreme environments can be effectively developed. The emergence of the high-entropy alloys provides a promising platform for the design of alloy composition system for the application of the frontier technology of microelectronic circuits and the next generation of high-frequency communication technology.

Since the 1990s, the emergence of amorphous/nanocrystalline composite soft magnetic materials has enabled FeCo-based alloys to obtain the low coercive force performance of FeNi-based alloys and have good saturation magnetization by doping amorphous elements for rapid quenching. The essential reason is that the nano-scale crystal particles less than ferromagnetic exchange length are induced in the amorphous matrix so that the diffusely distributed nanocrystalline particles are in a state of single domain, which greatly improves the ability of responding to the external field and obtains good comprehensive performance. The alloy will show excellent soft magnetic properties only by properly controlling the size of nano-particles diffusely distributed in the matrix; and the smaller the diameter of the nano-particles is, the higher the degree of coherence is, and the better the soft magnetic properties of the alloy should be. It should be noted that the amorphous/nanocrystalline composite soft magnetic materials have certain limitations in the material forming methods, and cannot meet the severe service environment test, so it is not possible to replace the traditional metal crystalline materials.

The room-temperature phase of the FeCoNiSiAl alloy system has a body-centered cubic structure (bec) and a face-centered cubic structure (fcc) with the difference of element contents. The elements are classified by magnetism at room temperature: Fe, Co and Ni are ferromagnetic, Si is antimagnetic, and Al is paramagnetic. In terms of magnetic ordering of the phase, the fcc phase is weakly magnetic; and the bec phase is usually ferromagnetic. In the field of metal structural materials, the mechanical properties and high-temperature softening resistance of alloys are often greatly enhanced by regulating the amplitude-modulation decomposition structure such as bec and ordered B2 co-existing in a braided network. However, the microstructure configuration with a large misfit will significantly reduce the soft magnetic properties of alloys (such as high-entropy alloy with the coercive force of 1000 Oe reported in the literature). In a simple alloy system, it is impossible to regulate the distribution of the ordered phase and the matrix in the microstructure composed of binary ordered intermetallic compounds and terminal solid solutions. However, in a multi-component high-entropy system, it is expected to obtain features of proper phase distribution, phase fraction, lattice constant and lattice misfit in the matrix structure, including but not limited to A1, A2, B2, D0₃, L1₂ and L2₁, by changing the molar ratio of multiple principal elements.

Therefore, it is expected to develop new alloys that can meet the requirements of soft magnetic application conditions in the new era through the exploration of high-entropy alloy composition systems in combination with the comprehensive regulation of the alloy microstructure.

### SUMMARY

The purpose of the present invention is to provide a high-entropy soft magnetic alloy with 900 K high-temperature resistance, and to develop a novel multi-principal element FeCoNi-based Heusler soft magnetic high-entropy alloy with coherent precipitation of nanoparticles on a matrix and with 900 K high-temperature resistance in view that the microstructure morphology of the diffusely distributed nano-scale second phase with excellent comprehensive soft magnetic properties cannot be obtained for the disordered/ordered matrix in the FeCoNiSiAl multi-principal element high-entropy alloy.

To achieve the above purpose, the present invention provides a high-entropy soft magnetic alloy with 900 K high-temperature resistance, wherein the high-entropy soft magnetic alloy with 900 K high-temperature resistance comprises Fe, Co, Ni, Si and Al, and the atomic percent of the alloy composition is expressed as FeₓCo_{y}Ni_{z}SiₘAlₙ, wherein x=40%-80%, y=20%-60%, z=0-30%, m=0-20%, n=0-20%, and x+y+z+m+n=100%.

Preferably, the high-entropy soft magnetic alloy with 900 K high-temperature resistance also contains the following (a) and (b):
(a) In addition to the above five elements, the doping atomic percent of the sixth and more elements is p=0-5%;
(b) The atomic percent ratio of Si to Al is 0.5≤m/n≤3.

Preferably, the sixth and more elements are one of Nb, V, Ti, Mn and Ga.

Preferably, the high-entropy soft magnetic alloy with 900 K high-temperature resistance has coherent structure morphology: in a matrix structure, including but not limited to coherent precipitation of 10-100 nm-scale second phase particles on A1, A2, B2, D0₃, L1₂ and L2₁, and the particles have ferromagnetism.

Preferably, the nano-scale second phase particles are continuously and diffusely distributed in the matrix structure.

Preferably, the typical performance indexes of the high-entropy soft magnetic alloy with 900 K high-temperature resistance include: for series alloys, at room temperature, saturation magnetization Mₛ=90-150 emu/g, and coercive force H_{c}=0.1-15 Oe; and at 900 K, saturation magnetization Mₛ=70-130 emu/g, and coercive force H_{c}=0.1-25 Oe.

The concept of the present invention to realize the top-level design scheme of alloy composition is as follows:

Firstly, the principal elements in high-entropy alloys are divided into two categories: ferromagnetic origin elements Fe, Co and Ni and structural elements Si and Al as well as a possible sixth element or more elements. Based on the idea of the Materials Genome Initiative, the phase area where intermetallic compounds may exist is identified by means of high-throughput preparation and computational materials science.

Then, the selected composition range is explored by means of precipitate regulation commonly used in high-entropy alloys, and a simple mapping relationship between physical properties and performance of materials is established by collecting and summing up the basic physical property information of component alloys in the special phase area.

Finally, the distribution pattern and relative content of the microstructure in the final alloy composition are regulated by designing the correlation between clusters and the cooling rate. Based on the feature of high affinity of Ni, Al and Si atoms, the final state models of materials with different precipitate features are designed, and the high-entropy alloy system with excellent soft magnetic properties is finally established.

The research and development efficiency of multi-principal element high-entropy alloys with high performance is greatly improved by using the top-level design rule of alloy composition.

It should be noted that two additional constraints are required for obtaining nano-scale precipitates with smaller size in the matrix. First, for the relative content of the matrix structure and nano-precipitates, Si and Al involved in the present application are respectively a complex phase forming element and a simple phase forming element when forming Heusler intermetallic compounds. The interaction between Ni and Al is stronger, and when the content of Ni is too high, Ni and Al will preferentially form a B2 phase. Therefore, in order to ensure the formation of the special microstructure in the present application, it is necessary to increase the content of Ni. Second, in order to ensure that the alloy in the present invention has more excellent soft magnetic properties, it is necessary to ensure the content of ferromagnetic elements in the nano-particles, that is, to regulate the content of Fe/Co/Ni as a whole. Therefore, the present application further defines the atomic percent p of the sixth (doping) element and the atomic percent m and n of Si and Al.

The preparation method of the present invention is as follows: 99.98% high-purity element materials are used, and the atomic percent is converted to the mass fraction for mixing; a mixture with the total mass of 50 g is placed in a water cooled copper crucible of a non-consumable vacuum electric arc furnace; then, the alloy ingot is smelted by arc strike in an argon protective atmosphere and repeatedly smelted for five times to ensure uniform composition of the alloy ingot; and finally, the uniformly smelted alloy ingot is melted, and the melt is sucked into a cylindrical copper mold cavity by means of copper mold suction casting to obtain a rod-shaped sample with a diameter of 10 mm after cooling.

The microstructure configuration of the alloy is characterized by a metallographic microscope (OM), a scanning electron microscope (SEM), a transmission electron microscope (TEM) and an X-ray diffractometer (XRD, Cu Kα radiation, λ=0.15406 nm). The room-temperature and high-temperature hysteresis loops of the alloy are measured by a vibrating sample magnetometer (VSM). Accordingly, the present invention is determined to be the above high-entropy soft magnetic alloy with 900 K high-temperature resistance.

Compared with traditional soft magnetic alloys, the present invention has the following advantages:

The present invention is a high-entropy soft magnetic alloy with 900 K high-temperature resistance developed by the inventor based on the idea of the Materials Genome Initiative by regulating the precipitate distribution characteristics of the nano-scale second phase in the alloy. By changing the relative contents of structural and ferromagnetic elements, the relative contents of three ferromagnetic elements Fe, Co and Ni and the content of a possible sixth (and more) doping elements are adjusted so as to realize the reasonable regulation of diffuse distribution of nano-scale coherent precipitates in the matrix structure and establish the composition regulation criteria, shielding the traditional cumbersome “stir-fry” empirical alloy design method.

In addition, the soft magnetic properties of Heusler high-entropy alloys at room temperature and high temperature are improved effectively in the special phase area highly related to the composition. Because the precipitate and the matrix structure maintain a good coherent relationship at room temperature and high temperature, and the lattice constants are basically the same, the magnetic domain is easy to flip so that the alloy has excellent soft magnetic properties at room temperature and high temperature, which maximizes the saturation magnetization of the alloy and reduce the coercive force, so as to develop the Heusler soft magnetic high-entropy alloy in a multi-principal element alloying mode.

Finally, due to the coherent precipitation of nano-particles in the matrix structure, the nano precipitate is not easy to grow up so as to enable the microstructure to have excellent high-temperature structure stability so that the alloy can still maintain good soft magnetic properties in a 900 K high temperature environment. The typical performance indexes of the material include: for series alloys, at room temperature, saturation magnetization Mₛ=90-150 emu/g, and coercive force H_{c}=0.1-15 Oe; and at 900 K, saturation magnetization Mₛ=70-130 emu/g, and coercive force H_{c}=0.1-25 Oe.

Therefore, the high-entropy soft magnetic alloy with 900 K high-temperature resistance of the present invention using the above structure has the following beneficial effects:
(1) Through the top-level design of alloy composition, the ratio of the principal elements of the novel soft magnetic high-entropy alloy system is rationalized, so as to realize a soft magnetic high-entropy alloy with 900 K high-temperature resistance.
(2) The preparation process and forming method of the alloy are simple, and a non-consumable vacuum electric arc furnace is used for smelting;
(3) The precipitates with the sizes of 10-100 nm are diffusely distributed in the matrix structure, and such special microstructure configuration makes the high-entropy alloy show excellent soft magnetic properties.

The technical solution of the present invention is further described in detail below by the accompanying drawings and embodiments.

### DESCRIPTION OF DRAWINGS

FIG. 1 is a TEM diagram of an Fe_{36.87}Co_{7.37}Ni_{29.50}Si_{16.56}Al_{9.70} (at. %) alloy prepared in embodiment 1, wherein the precipitate particles (with a diameter of about 10 nm) are coherently precipitated by means of continuous diffusion in the matrix structure;

FIG. 2 is a hysteresis graph of an Fe_{36.87}Co_{7.37}Ni_{29.50}Si_{16.56}Al_{9.70} (at. %) alloy prepared in embodiment 1, wherein the abscissa is an applied magnetic field, and the ordinate is magnetization;

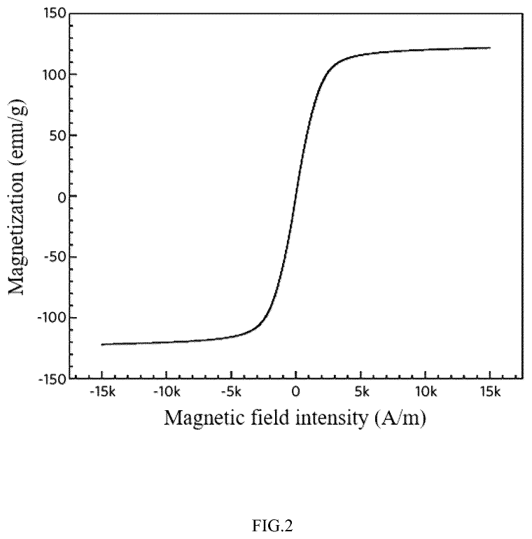

FIG. 3 is a coercive force graph of an Fe_{36.87}Co_{7.37}Ni_{29.50}Si_{16.56}Al_{9.70} (at. %) alloy prepared in embodiment 1, wherein the abscissa is an applied magnetic field, and the ordinate is magnetization.

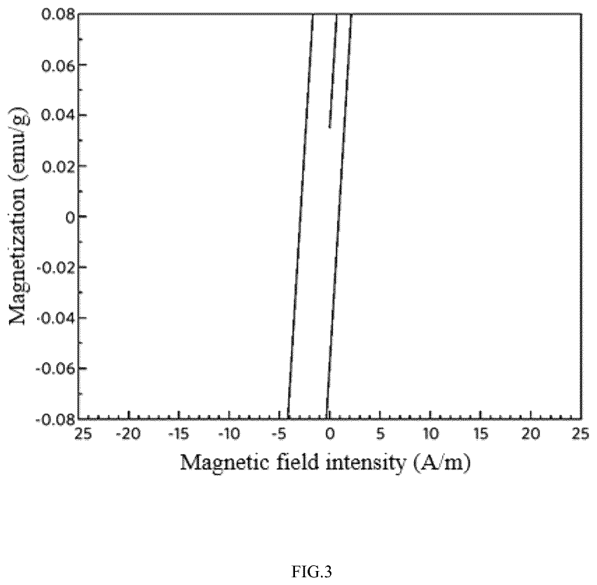

### DETAILED DESCRIPTION

The present invention is further described in detail below. It should be noted that detailed implementation modes and specific operation procedures are given by the embodiments on the premise of the present invention, but the present invention is not limited to the embodiments.

### Embodiment 1

Quinary Fe_{36.87}Co_{7.37}Ni_{29.50}Si_{16.56}Al_{9.70} (at. %) Alloy

Step 1: Alloy Preparation

A high-entropy soft magnetic alloy with 900 K high-temperature resistance Fe_{36.87}Co_{7.37}Ni_{29.50}Si_{16.56}Al_{9.70} (at. %). High-purity pure elements are used as alloy raw materials, and the atomic ratio of alloy composition is converted to the mass percent for mixing, thus obtaining 42Fe-9Co-35Ni-9Si-5Al (wt. %). 50 g of mixture is placed in a water cooled copper crucible of a non-consumable electric arc furnace, then vacuumed by a mechanical pump and a molecular pump in sequence, filled with high-purity argon, purged, smelted in an argon protective atmosphere, and repeatedly smelted for five times to ensure uniform composition of the alloy ingot. The uniformly smelted alloy ingot is melted, and the melt is sucked into a cylindrical copper mold cavity by means of copper mold suction casting to obtain a rod-shaped sample with a diameter of 10 mm.

Step 2: Test of Alloy Structure and Magnetic Properties

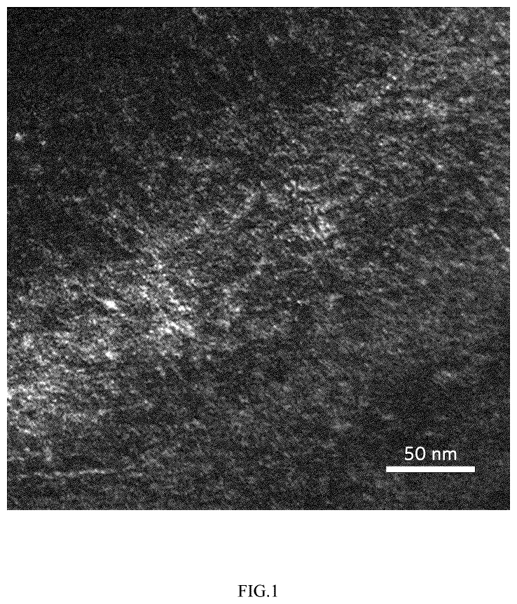

The microstructure configuration of the homogenized alloy is detected by characterization methods such as OM, SEM, XRD and TEM, and the result shows that the alloy of the present invention has a specific coherent nanostructure: the second phase nanoparticles are coherently precipitated by means of continuous diffusion in the matrix structure, as shown in FIG. 1; the hysteresis loop is measured by a vibrating sample magnetometer (VSM), at room temperature, saturation magnetization Mₛ=120 emu/g, and coercive force H_{c}=2.5 Oe; and at 900 K, saturation magnetization Mₛ=96 emu/g, and coercive force H_{c}=2 Oe.

### Embodiment 2

Six-Element (Fe_{67.84}Co_{1.47}Ni_{4.42}Si_{16.60}Al_{9.67})₉₇Nb₃ (at. %) Alloy

Step 1: Alloy Preparation

A high-entropy soft magnetic alloy with 900 K high-temperature resistance (Fe_{67.84}Co_{1.47}Ni_{4.42}Si_{16.60}Al_{9.67})₉₇Nb₃ (at. %). High-purity pure elements are used as alloy raw materials, and the atomic ratio of alloy composition is converted to the mass percent for mixing, thus obtaining 78Fe-2Co-5Ni-10Si-5Al (wt. %). 50 g of mixture is placed in a water cooled copper crucible of a non-consumable electric arc furnace, then vacuumed by a mechanical pump and a molecular pump in sequence, filled with high-purity argon, purged, smelted in an argon protective atmosphere, and repeatedly smelted for five times to ensure uniform composition of the alloy ingot so as to prepare a prealloy ingot. Then 3 at. % of elementary Nb is weighed according to the mass of the peeled and fine ground prealloy ingot and smelted, the uniformly smelted liquid metal is subjected to copper mold suction casting, and the melt is sucked into a cylindrical copper mold cavity to obtain a rod-shaped sample with a diameter of 10 mm.

Step 2: Test of Alloy Structure and Magnetic Properties

The microstructure configuration of the homogenized alloy is detected by characterization methods such as OM, SEM, XRD and TEM, and the result shows that the alloy of the present invention has a specific coherent nanostructure: the second phase nanoparticles are coherently precipitated by means of continuous diffusion in the matrix structure; the hysteresis loop is measured by a vibrating sample magnetometer (VSM), at room temperature, saturation magnetization Mₛ=124 emu/g, and coercive force H_{c}=0.8 Oe; and at 900 K, saturation magnetization Mₛ=83.4 emu/g, and coercive force H_{c}=0.7 Oe.

### Embodiment 3

Six-Element (Fe_{36.87}Co_{29.50}Ni_{7.37}Si_{16.56}Al_{9.7})₉₅Ga₅ (at. %) Alloy

Step 1: Alloy Preparation

A high-entropy soft magnetic alloy with 900 K high-temperature resistance (Fe_{67.84}Co_{1.47}Ni_{4.42}Si_{16.60}Al_{9.67})₉₅Ga₅ (at. %). High-purity pure elements are used as alloy raw materials, and the atomic ratio of alloy composition is converted to the mass percent for mixing, thus obtaining 42Fe-35Co-8Ni-10Si-5Al (wt. %). 50 g of mixture is placed in a water cooled copper crucible of a non-consumable electric arc furnace, then vacuumed by a mechanical pump and a molecular pump in sequence, filled with high-purity argon, purged, smelted in an argon protective atmosphere, and repeatedly smelted for five times to ensure uniform composition of the alloy ingot so as to prepare a prealloy ingot. Then 5 at. % of elementary Ga is weighed according to the mass of the peeled and fine ground prealloy ingot and smelted, the uniformly smelted liquid metal is subjected to copper mold suction casting, and the melt is sucked into a cylindrical copper mold cavity to obtain a rod-shaped sample with a diameter of 10 mm.

Step 2: Test of Alloy Structure and Magnetic Properties

The microstructure configuration of the homogenized alloy is detected by characterization methods such as OM, SEM, XRD and TEM, and the result shows that the alloy of the present invention has a specific coherent nanostructure: the second phase nanoparticles are coherently precipitated by means of continuous diffusion in the matrix structure; the hysteresis loop is measured by a vibrating sample magnetometer (VSM), at room temperature, saturation magnetization Mₛ=126 emu/g, and coercive force H_{c}=10.4 Oe; and at 900 K, saturation magnetization Mₛ=89.4 emu/g, and coercive force H_{c}=10 Oe.

Meanwhile, the chemical composition of the high-entropy soft magnetic alloys with 900 K high-temperature resistance No. 1-20 shown in Table 1 is the same as the source of the composition. As mentioned above, the present invention can be better realized.

In addition, the chemical composition in Table 1 belongs to a high-entropy soft magnetic alloy with 900 K high-temperature resistance. However, the composition of a high-entropy soft magnetic alloy with 900 K high-temperature resistance designed by the patent is not limited to this table. “-” indicates that the element is not added.

TABLE 1

| | Alloy Element (wt. %) | | | | |
|---|---|---|---|---|---|
| No. | Fe | Co | Ni | Si | Al |
| 1 | 62 | 20 | — | 14 | 4 |
| 2 | 47 | 22 | 12 | 14 | 5 |
| 3 | 42 | 24 | 14 | 14 | 6 |
| 4 | 37 | 26 | 16 | 14 | 7 |
| 5 | 32 | 28 | 18 | 14 | 8 |
| 6 | 27 | 30 | 20 | 14 | 9 |
| 7 | 22 | 32 | 22 | 14 | 10 |
| 8 | 58 | 20 | — | 18 | 4 |
| 9 | 43 | 22 | 12 | 18 | 5 |
| 10 | 38 | 24 | 14 | 18 | 6 |
| 11 | 33 | 26 | 16 | 18 | 7 |
| 12 | 28 | 28 | 18 | 18 | 8 |
| 13 | 23 | 30 | 20 | 18 | 9 |
| 14 | 18 | 32 | 22 | 18 | 10 |
| 15 | 54 | 20 | 12 | 10 | 4 |
| 16 | 49 | 22 | 14 | 10 | 5 |
| 17 | 44 | 24 | 16 | 10 | 6 |
| 18 | 39 | 26 | 18 | 10 | 7 |
| 19 | 34 | 28 | 20 | 10 | 8 |
| 20 | 29 | 30 | 22 | 10 | 9 |

Therefore, the high-entropy soft magnetic alloy with 900 K high-temperature resistance of the present invention realizes the continuously diffuse distribution of nano-scale precipitates in the matrix structure by comprehensively regulating the microstructure configuration of the multi-principal element alloy, thus improving the soft magnetic properties of the alloy to a certain extent, and the processing route is simple and reliable, with high repeatability.

Finally, it should be noted that the above embodiments are only used for describing, rather than limiting the technical solution of the present invention. Although the present invention is described in detail concerning the preferred embodiments, those ordinary skilled in the art shall understand that the technical solution of the present invention can still be amended or equivalently replaced. However, these amendments or equivalent replacements shall not enable the amended technical solution to depart from the spirit and the scope of the technical solution of the present invention.

What is claimed is:

1. A high-entropy soft magnetic alloy with 900 K high-temperature resistance, wherein the high-entropy soft magnetic alloy with 900 K high-temperature resistance comprises Fe, Co, Ni, Si and Al, and the atomic percent of the alloy composition is expressed as FeₓCo_{y}Ni_{z}SiₘAlₙ, wherein x=40%-80%, y=20%-60%, z=0-30%, m=0-20%, n=0-20%, and x+y+z+m+n=100%.

2. The high-entropy soft magnetic alloy with 900 K high-temperature resistance according to claim 1, wherein the high-entropy soft magnetic alloy with 900 K high-temperature resistance also contains the following (a) and (b):
(a) in addition to the above five elements, the doping atomic percent of the sixth and more elements is p=0-5%;
(b) the atomic percent ratio of Si to Al is 0.5≤m/n≤3.

3. The high-entropy soft magnetic alloy with 900 K high-temperature resistance according to claim 2, wherein the sixth and more elements are one of Nb, V, Ti, Mn and Ga.

4. The high-entropy soft magnetic alloy with 900 K high-temperature resistance according to claim 1, wherein the high-entropy soft magnetic alloy with 900 K high-temperature resistance has coherent structure morphology: in a matrix structure, including but not limited to coherent precipitation of 10-100 nm-scale second phase particles on A1, A2, B2, D0₃, L1₂ and L2₁, and the particles have ferromagnetism.

5. The high-entropy soft magnetic alloy with 900 K high-temperature resistance according to claim 4, wherein the nano-scale second phase particles are continuously and diffusely distributed in the matrix structure.

6. The high-entropy soft magnetic alloy with 900 K high-temperature resistance according to claim 1, wherein the typical performance indexes of the high-entropy soft magnetic alloy with 900 K high-temperature resistance include: for series alloys, at room temperature, saturation magnetization Mₛ=90-150 emu/g, and coercive force H_{c}=0.1-15 Oe; and at 900 K, saturation magnetization Mₛ=70-130 emu/g, and coercive force H_{c}=0.1-25 Oe.

7. The high-entropy soft magnetic alloy with 900 K high-temperature resistance according to claim 2, wherein the typical performance indexes of the high-entropy soft magnetic alloy with 900 K high-temperature resistance include: for series alloys, at room temperature, saturation magnetization Mₛ=90-150 emu/g, and coercive force H_{c}=0.1-15 Oe; and at 900 K, saturation magnetization Mₛ=70-130 emu/g, and coercive force H_{c}=0.1-25 Oe.

8. The high-entropy soft magnetic alloy with 900 K high-temperature resistance according to claim 3, wherein the typical performance indexes of the high-entropy soft magnetic alloy with 900 K high-temperature resistance include: for series alloys, at room temperature, saturation magnetization Mₛ=90-150 emu/g, and coercive force H_{c}=0.1-15 Oe; and at 900 K, saturation magnetization Mₛ=70-130 emu/g, and coercive force H_{c}=0.1-25 Oe.

9. The high-entropy soft magnetic alloy with 900 K high-temperature resistance according to claim 4, wherein the typical performance indexes of the high-entropy soft magnetic alloy with 900 K high-temperature resistance include: for series alloys, at room temperature, saturation magnetization Mₛ=90-150 emu/g, and coercive force H_{c}=0.1-15 Oe; and at 900 K, saturation magnetization Mₛ=70-130 emu/g, and coercive force H_{c}=0.1-25 Oe.

10. The high-entropy soft magnetic alloy with 900 K high-temperature resistance according to claim 5, wherein the typical performance indexes of the high-entropy soft magnetic alloy with 900 K high-temperature resistance include: for series alloys, at room temperature, saturation magnetization Mₛ=90-150 emu/g, and coercive force H_{c}=0.1-15 Oe; and at 900 K, saturation magnetization Mₛ=70-130 emu/g, and coercive force H_{c}=0.1-25 Oe.
